(19) United States
(12) Patent Application Publication
(10) Pub. No.: US 2008/0302709 A1
(43) Pub. Date: Dec. 11, 2008

(54) Method for Monitoring the Degree of Clogging of the Filtration Surface of an Oil Filter

(76) Inventor: Adrian Colin Jefferies, Berkshire (GB)

Correspondence Address: NIXON & VANDERHYE, PC, 901 NORTH GLEBE ROAD, 11TH FLOOR, ARLINGTON, VA, 22203, US

(21) Appl. No.: 12/085,199

(22) PCT Filed: Nov. 22, 2006
(86) PCT No.: PCT/GB2006/004356

§ 371 Date: May 19, 2008

(30) Foreign Application Priority Data
Nov. 28, 2005 (EP) 05257302.9

(51) Int. Cl. B01D 27/10; B01D 35/143

(52) U.S. Cl. 210/92

(57) ABSTRACT

A method for determining the condition of an engine lubricant passing through an engine and a filtration apparatus (1) with a filter by-pass valve (6) comprises determining whether the lubricant needs replacing according to whether a detector (9) detects that the extent to which the by-pass value (6) is at least partially open exceeds a pre-determined value.

The present invention relates to a method for determining the condition of a lubricant and in particular to a method for determining the condition of an engine lubricant.

Engine lubricants are typically filtered in use to remove solid particles, such as soot, metal and other debris that would otherwise accumulate with time and potentially cause damage to the engine, which is being lubricated. The solid particles may be created through a variety of processes, for example by degradation of the lubricant and/or by wear of moving parts in the engine. A typical engine lubricant filtration apparatus comprises a housing adapted to receive a lubricant filter and has an inlet and an outlet such that in use, lubricant entering the housing through the inlet passes through the filter and leaves the housing through the outlet. Over time the filter may become at least partially blocked with solid particles which restrict the passage of lubricant through the filter, causing a back-pressure on the lubricant passing through the filter.

The lubricant filtration apparatus may be provided with a by-pass valve adapted in use to open and pass at least some of the lubricant between the inlet and the outlet without passing through the filter when back pressure on the lubricant passing through the filter exceeds a predetermined value. Typically, the by-pass valve will close again if the back-pressure on lubricant passing through the filter falls below the predetermined value.

U.S. Pat. No. 6,666,968 relates to an oil filter assembly with a bypass section.

A problem associated with a lubricant filtration apparatus by-pass valve is that, when opened, at least some of the lubricant is not passed through the filter and so is not filtered. This results in less efficient removal of solid particles from the lubricant and may increase the potential for engine damage to occur. To mitigate damage to the engine and to improve engine performance, the lubricant and filter are typically replaced at regular intervals that are calculated, for example, on the basis of the engine mileage since the previous lubricant and filter replacement. However, in order to extend the lifetime of the lubricant, it would be desirable to replace the lubricant only when the quality of the lubricant is below a predetermined level.

U.S. Pat. No. 3,323,648 relates to a filter device with means for indicating the clogged condition of the filter element. U.S. Pat. No. 6,471,853 relates to a filter module incorporating sensors to measure various characteristics of the fluid flow and filtration. U.S. Pat. No. 4,747,378 relates to an oil filter for internal combustion engines, particularly of motor vehicles with members for monitoring the degree of clogging of the filtration surface. U.S. Pat. No. 4,747,378 contemplates the need to replace a filter when it becomes clogged it does not relate to oil condition monitoring and in particular determining the need to replace the lubricant.

Analytical methods are known for determining the extent of degradation of engine lubricants, such as dielectric measurements, viscosity measurements and algorithms relating to engine usage. However, a problem with such techniques is that contaminants, such as water, may accumulate in the lubricant with use, which can negatively affect the accuracy of the measurements and/or algorithms. Additionally, in the case of viscosity measurements, these must be combined with temperature measurements in order for the results to be meaningful.

There remains a need for a method which overcomes or at least mitigates these problems.

According to the present invention there is provided a method for determining the condition of an engine lubricant, which method comprises providing an engine with an engine lubricant filtration apparatus comprising a housing adapted to receive a lubricant filter and having an inlet and an outlet such that in use, lubricant entering the housing through the inlet passes through the filter and leaves the housing through the outlet, the apparatus having a by-pass valve adapted in use to open and pass at least some of the lubricant between the inlet and the outlet without passing through the filter when back pressure on the lubricant passing through the filter exceeds a predetermined value and the lubricant filtration apparatus further comprising a detector for detecting the extent to which the by-pass valve is at least partially open; passing engine lubricant through the engine to lubricate it; passing the lubricant through the filtration apparatus to filter the lubricant and determining whether the lubricant needs replacing according to whether the detector detects that the extent to which the by-pass value is at least partially open exceeds a pre-determined value.

The present invention solve the technical problem defined by the use of a detector, which detects the extent to which the by-pass valve is at least partially open and hence is able to provide information relating to the condition of the lubricant and in particular whether the lubricant needs replacing. The condition of the lubricant usually depends upon the extent of degradation of the lubricant in use. The present invention is advantageous over other methods, such as calculations based on the engine mileage since the previous replacement of the lubricant, which may be inaccurate. The present invention can provide an indication of the condition of the lubricant requiring that it be changed earlier than would be determined by engine mileage, for example if the lubricant has become degraded due to arduous operation of the engine.

The filtration apparatus comprises a detector which detects the extent to which the by-pass valve is at least partially open. In one embodiment, the by-pass valve may adopt only fully open or fully closed positions. In an alternative embodiment the by-pass valve may also adopt partially open positions, depending on the back pressure on the lubricant passing through the filter. The detector may detect whether the by-pass valve is fully open or fully closed. The detector may detect the extent of the opening of the by-pass valve. The detector may detect whether the by-pass valve is fully open, fully closed or partially open.

The detector may comprise a mechanical device, such as a pointer, that adopts different positions depending on whether the by-pass valve is fully open, fully closed, or partially open. The detector may be a resistance detector. Such a resistance detector may determine resistance of an electrical circuit including the by-pass valve to determine whether there is an open or closed circuit according to whether the by-pass valve is respectively open or closed. The detector may be a capacitance measurement device. Such a capacitance measurement device may determine capacitance of a circuit including the by-pass valve, which capacitance depends upon whether the by-pass valve is fully open, partially open or closed. The detector may be a thermistor. Such a thermistor may measure the temperature differential across the by-pass valve (temperature differential changes when oil flows through the by-pass valve).

In another embodiment, the detector may measure the rate of flow of lubricant through the by-pass valve for example to determine whether the by-pass valve is fully open, fully closed or partially open. A suitable detector for measuring the flow of lubricant is a coriolis meter.

In the present invention, the extent to which the by-pass valve is at least partially open may be detected according to one or more of the following parameters:

the time period during which the by-pass valve is at least partially open;

the extent of opening of the by-pass valve;

whether the by-pass valve is fully open or fully closed;

whether the by-pass valve is fully open, partially open or fully closed;

the rate of flow of lubricant through the by-pass valve.

The detector may be adapted to transmit a signal relating to the whether the by-pass valve is fully open, fully closed or partially open. The signal may be transmitted to an indicator. The indicator may be an audible indicator and/or a visual indicator. The indicator may be an electronic indicator. The indicator may be for example a light bulb, a light emitting diode or a liquid crystal display. The indicator may be an audible indicator, for example a loudspeaker. The signal may be transmitted from the sensor to the indicator by wires, or as a radio signal.

The housing of the lubricant filtration apparatus may be constructed of metal such as steel or aluminium. The filter may be a spin-on or cartridge filter.

The present invention may be used with any type of internal combustion engines, for example compression ignition engines or spark ignition engines. The engine may be used in a vehicle, for example a passenger car or a truck.

The present invention may be used with any type of lubricant. Suitably, the lubricant is an automotive crankcase lubricant.

In the method of the present invention the lubricant may be passed though the engine to lubricant the engine's oil pump, valve train, piston ring liner interface, bearings and timing chain.

Preferably, the by-pass valve is a sprung valve. A suitable sprung by-pass valve may be a simple plastic part contained in a metal housing by a spring (for example as commercially available from Fram®) or a rubber diaphragm attached to a sprung metal plate which is held in a housing (for example as commercially available from Wix®). The predetermined back pressure at which the by-pass valve opens to pass at least some of the lubricant is determined by the spring strength or spring action of the sprung plate.

The predetermined value of back-pressure on lubricant passing through the filter is preferably set so that a sufficient flow of lubricant is maintained through the filter. For example, the predetermined value should be set so that a continuous flow of lubricant through the filter is maintained. However, in order to have a useful lifetime of the lubricant filter and/or the lubricant, the predetermined value should not be set too low, thus causing the by-pass valve to open when the lubricant filter is still able adequately to filter the lubricant. Most engines use oils having a lubricant viscosity range of 5 to 21.9 Cst at 100° C. Engine operating pressures will depend on engine speed; bigger engines are likely to have lower operating pressures.

The predetermined back-pressure on the lubricant passing through the filter, (which is a differential pressure between the inlet pressure and the outlet pressure across the filter), at which the by-pass valve at least partially opens is typically less than 200 psi (1380 kPa). The predetermined back-pressure is suitably at least 5 psi (35 kPa), preferably at least 12 psi (83 kPa), more preferably at least 15 psi (103 kPa), such as at least 20 psi (138 kPa).

Typically, the flow rate of the lubricant through the filtration apparatus is in the range from 0 to 180/min, preferably from 301/min to 1501/min, more preferably from 60 l/min to 120 l/min.

An advantage of the method of the present invention is that it is capable of determining the condition of the oil which leads to multiple causes of flow restriction through the lubricant filter, for example, viscosity increase of the lubricant through degradation, sludge, or blockage of the filter by solid particles in the lubricant, for example metal particles, solid lubricant fuel oxidation residues and/or soot particles.

In the method of the present invention, the detector may periodically or continuously detect the extent to which the by-pass valve is at least partially open. The information so-obtained can then be used to determine whether the lubricant requires replacement. Thus, when the detector detects that the extent to which the by-pass valve is at least partially open exceeds a pre-determined value, this can be correlated with the condition of the lubricant, for example the viscosity of the lubricant being such that the flow of lubricant through the filter is restricted beyond an unacceptable level.

The method of the present invention may comprise detecting the extent to which the by-pass valve is at least partially open according to the time period during which the by-pass valve is at least partially open and then determining whether this exceeds a pre-determined value. Thus, if the by-pass valve is detected to be at least partially open for a time period of at least 5 minutes, more preferably at least 10 minutes, then it may be determined that the lubricant needs to be replaced. This can allow for fluctuations in lubricant pressure and changes in viscosity of the lubricant, for example at start-up or when the engine is otherwise cold. An apparatus suitable for carrying out this determination may comprise a timer for example an electronic timer, triggered by the by-pass opening, and stopping when the by-pass shuts. If the timer determines that the time period during which the by-pass valve is open exceeds a predetermined value (for example 5 or 10 minutes) it can be determined that the lubricant needs replacing and this indicated by an indicator.

Lubricants are generally more viscous at lower temperatures. Thus, the lubricant may have a high viscosity when the engine is cold (for example if the engine has just been started), which may consequently cause the filter by-pass valve to open at least partially even thought the lubricant may not need replacing. Therefore, in one embodiment, the method of the present invention is preferably performed on a warm engine, preferably when the lubricant has reached a typical operating temperature. A typical operating temperature may be in the range 80-100° C. or 90-110° C. For example, for a two litre petrol engine the typical operating temperature of the lubricant may be in the range of 80-100° C. and for a two litre diesel engine in the range of 90-110° C.

Similarly, in another embodiment, the method of the present invention is preferably performed on an engine which has been operated continuously for a predetermined period of time. A suitable period of time may be determined to be a time after which most engines will have warmed up sufficiently to reduce the viscosity of the lubricant sufficiently to close the by-pass valve. Such a suitable time may be for example, at least 5 minutes.

The lubricant may be replaced by substituting at least part of the engine lubricant with fresh, unused lubricant or by replacing it completely.

The filter need not be replaced when the lubricant is replaced, for example if it is difficult to access. Preferably, the filter is replaced when the lubricant is replaced. Preferably, re-conditioned filters are not used. This has an advantage of reducing the possibility that a mal-formed filter would cause the by-pass valve to open unnecessarily. The filter may be replaced by replacing the filter and its housing, for example as for a “spin-on” filter apparatus. The filter alone may be replaced without replacing the housing for example as with a cartridge filter apparatus.

Many automobile engines use a spin-on filter, especially American automobile engines. Some European automobile engines use a cartridge filter, although the majority presently use a spin-on filter.

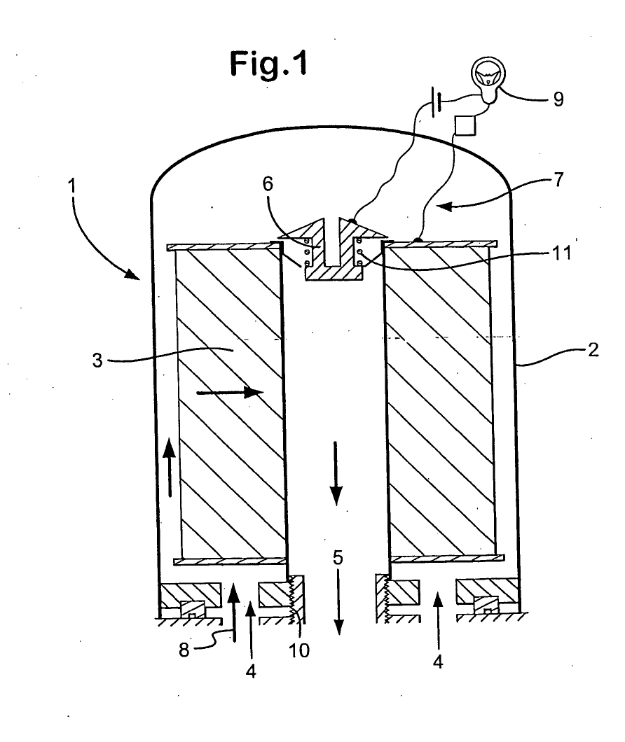

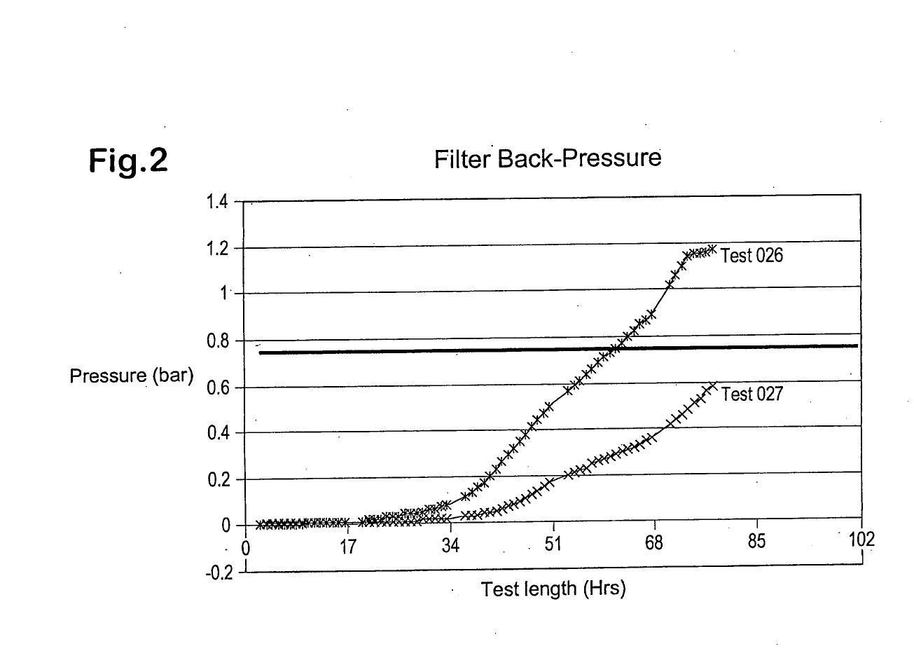

The invention will now be described by way of example only and with reference to FIGS. 1 and 2 in which

FIG. 1 represents, in simplified cross-section; apparatus for use in the method according to the present invention.

FIG. 2 represents, in graph form, the back-pressure on a lubricant passing through a filter and which back pressure can be used in the method of the present invention.

Referring to FIG. 1, the engine lubricant filtration apparatus (1) comprises a housing (2) adapted to receive a lubricant filter (3) and has an inlet (4) and an outlet (5). The apparatus has a by-pass valve (6) adapted in use to open and pass at least some of the lubricant between the inlet (4) and the outlet (5) without passing through the filter (3) when back pressure on the lubricant passing through the filter exceeds a predetermine value. The by-pass valve is a sprung by-pass valve held in the normally closed position by a spring (11) acting against the back-pressure on the lubricant passing through the filter apparatus. The apparatus has a detector (7) for detecting the extent to which the by-pass valve (6) is at least partially open. The detector (7), which may be a resistance detector or a capacitance detector, is connected electrically to an indicator (9), for example a light bulb which indicates whether the by-pass valve is at least partially open.

The apparatus (1) may be connected to an engine (not shown) by screw thread (10).

In use, lubricant (8) entering the housing (2) through the inlet (4) passes through the filter (3) and leaves the housing (2) through the outlet (5). When back pressure on the lubricant passing through the filter exceeds a predetermine value the by-pass valve (6) opens and passes at least some of the lubricant (8) between the inlet (4) and the outlet (5) without passing through the filter (3). The detector (7) detects the extent to which the by-pass valve (6) is at least partially open and passes a signal to the indicator (9).

The apparatus shown in FIG. 1 may be used in the method of the present invention. Thus, the lubricant filtration apparatus (1) may be connected to an engine (not shown) by screw thread (10). Crankcase engine lubricant (8) is passed through the engine to lubricate it and passed through the filtration apparatus (1) to filter it. Whether the lubricant (8) needs replacing is determined according to whether the detector (7) detects that the extent to which the by-pass-valve (6) is at least partially open exceeds a pre-determined value.

FIG. 2 shows in graph form, the back-pressure on lubricants passing through a filter in an engine lubricant filtration apparatus (which was not apparatus for use in the method according to the present invention because it did not have a by-pass valve or a detector for detecting the extent to which the by-pass valve is at least partially open). The filter apparatus was fitted to a Cummins M11 engine and the back pressure measured during operation.

In FIG. 2, two different engine lubricants were used and the engine was operated for up to about 70 hours under different operating conditions whilst the back-pressure was monitored. The graph shows that the back-pressure increased for each lubricant—but at different rates. A by-pass valve if set to open at a back pressure of 0.75 bar would be at least partially open after about 60 hours operation and if this opening were to be detected with a detector, that would enable it to be determined that the lubricant needs replacing for the test 026 at that time.

1-6. (canceled)

7. A method for determining the condition of an engine lubricant, which method comprises providing an engine with an engine lubricant filtration apparatus comprising a housing adapted to receive a lubricant filter and having an inlet and an outlet such that in use, lubricant entering the housing through the inlet passes through the filter and leaves the housing through the outlet, the apparatus having a by-pass valve adapted in use to open and pass at least some of the lubricant between the inlet and the outlet without passing through the filter when back pressure on the lubricant passing through the filter exceeds a predetermined value and the lubricant filtration apparatus further comprising a detector for detecting the extent to which the by-pass valve is at least partially open; passing engine lubricant through the engine to lubricate it; passing the lubricant through the filtration apparatus to filter the lubricant and determining whether the lubricant needs replacing according to whether the detector detects that the extent to which the by-pass value is at least partially open exceeds a pre-determined value, the extent to which the by-pass valve is at least partially open being detected according to the time period during which the by-pass valve is at least partially open.

8. A method as claimed in claim 7 which comprises determining whether the time period during which the by-pass valve is at least partially open exceeds a pre-determined value of at least 5 minutes.

9. A method as claimed in claim 7 which comprises periodically detecting the extent to which the by-pass valve is at least partially open.

10. A method as claimed in claim 8 which comprises periodically detecting the extent to which the by-pass valve is at least partially open.

11. A method as claimed in claim 7 which comprises continuously detecting the extent to which the by-pass valve is at least partially open.

12. A method as claimed in claim 8 which comprises continuously detecting the extent to which the by-pass valve is at least partially open.

13. A method as claimed in claim 7 when performed on a warm engine.

14. A method as claimed in claim 8 when performed on a warm engine.

15. A method as claimed in claim 9 when performed on a warm engine.

16. A method as claimed in claim 10 when performed on a warm engine.

17. A method as claimed in claim 11 when performed on a warm engine.

18. A method as claimed in claim 12 when performed on a warm engine.

19. A method as claimed in claim 7 when performed on an engine which has been operated continuously for a predetermined period of time of at least 5 minutes.

20. A method as claimed in claim 8 when performed on an engine which has been operated continuously for a predetermined period of time of at least 5 minutes.

21. A method as claimed in claim 9 when performed on an engine which has been operated continuously for a predetermined period of time of at least 5 minutes.

22. A method as claimed in claim 11 when performed on an engine which has been operated continuously for a predetermined period of time of at least 5 minutes.

23. A method as claimed in claim 13 when performed on an engine which has been operated continuously for a predetermined period of time of at least 5 minutes.
